(19) United States
(12) Patent Application Publication
(10) Pub. No.: US 2007/0067426 A1
(43) Pub. Date: Mar. 22, 2007

(54) Computer implemented methods for transferring files from a development environment to target mobile devices

(75) Inventors: Deepak K. Goyal, Shivpuri (IN); Sanjeev Agarwal, Alwar (IN); Prabodh Goel, Bangalore (IN)

Correspondence Address: MARTINE PENILLA & GENCARELLA, LLP, 710 LAKEWAY DRIVE, SUITE 200, SUNNYVALE, CA, 94085, US

(73) Assignee: SUN MICROSYSTEMS, INC., SANTA CLARA, CA (US)

(21) Appl. No.: 11/272,229

(22) Filed: Nov. 10, 2005

(30) Foreign Application Priority Data
Sep. 22, 2005 (IN) 2558/DEL/2005

(51) Int. Cl. G06F 15/173

(52) U.S. Cl. 709/223

(57) ABSTRACT

A method for deploying an application file from a development station directly to a mobile device is provided. The development station is configured to execute operations including the receiving of a list of mobile devices registered with an integrated development environment (IDE) application that is executed on the development station. The method further includes selecting a mobile device from the list mobile devices and selecting the application file to be deployed to the mobile device. The deploying of the application file to the mobile device triggers methods of a plug-in application. The plug-in application is configured to execute operations including the establishing of a wireless connection between the development station and the mobile device. Upon establishing the wireless connection, the plug-in application triggers the transferring of the application file to the mobile device over the wireless connection.

### BACKGROUND

1. Description of the Related Art

Embedded mobile devices, and in particular mobile phones, are used by consumers all around the world, with corresponding, and an ever-increasing, demand for additional conveniences and services. As consumer demands have grown, and new technologies have emerged, consumers are enjoying wider access to and use of diverse and complex applications on mobile devices. The Java™ 2 platform, Micro Edition (J2ME), is the edition of the Java 2 platform that is particularly useful for consumer electronics and embedded devices. The J2ME platform delivers the power and benefit of Java technology tailored for consumer-embedded devices. The J2ME provides a flexible user interface, a robust security model, a broad range of built-in network protocols, and support for networked and disconnected applications.

The J2ME platform defines configurations, profiles, and optional packages as elements for building complete Java runtime environments (JRE) that meet the requirements for a broad range of devices and target markets. Configurations are composed of a Java virtual machine (JVM) and a minimal set of class libraries. Examples of J2ME configurations include, connected limited device configuration (CLDC) and connected device configuration (CDC). Configurations can be combined with a set of high-level application program interfaces (APIs) or profiles that further define the application life cycle model, user interface, and access to device specific properties, to provide a complete runtime environment targeted at specific device categories. An example of one such profile is the mobile information device-profile (MIDP). The MIDP is especially useful for mobile phones and personal digital assistants (PDAs). The MIDP is a set of Java APIs, which, together with CLDC, provides a complete J2ME application runtime environment targeted at mobile information devices. However, J2ME applications (CLDC/MIDP) are required to be installed on the J2ME device.

The methods currently being used for installing the applications are via data cables, infrared, and over the air (OTA). The use of data cables are very much proprietary and original equipment manufacturers have their own protocol and interfaces (physical and logical). Therefore, from a developer's stand point, using multiple data cables and their drivers for different vendors can be cumbersome and costly. With regard to infrared, this can be a better option when compared to data cables. However, due to a limited range, the infrared option is not widely used. Also, most of the widely used APIs are not compatible with infrared. Even though OTA became standard with MIDP implementers, developers dislike the OTA method. There is a cost associated with each OTA file transfer. In some instances, such as testing and debugging, the same file may have to be transferred several times. The overhead resulting from transferring the same file repeatedly can be cost prohibitive. In addition, the developer has to depend on a third party such as a service provider to test the application. Besides, the OTA method is much slower compared to data cables and infrared.

Accordingly, there is a need for a process to transfer the Application files from any development station to real mobile devices without the disadvantages discussed above.

### SUMMARY

Broadly speaking, the present invention fills these needs by providing a system and a method for transferring Application files from a development station to a real mobile device. It should be appreciated that the present invention can be implemented in numerous ways, including as a method, a system, or a device. Several inventive embodiments of the present invention are described below.

A method for deploying an application file from a development station directly to a mobile device is provided. The development station is configured to execute operations including the receiving of a list of mobile devices registered with an integrated development environment (IDE) application that is executed on the development station. The method further includes selecting a mobile device from a list of registered mobile devices and selecting the application file to be deployed to the mobile device. The deploying of the application file to the mobile device triggers the methods of a plug-in application. The plug-in application is configured to execute operations including the establishing of a wireless connection between the development station and the mobile device. Upon establishing the wireless connection, the plug-in application triggers the transferring of the application file to the mobile device over the wireless connection.

In a further embodiment, the plug-in application integrates with features of the integrated development environment (IDE) application. The plug-in provides native-like functionality for the direct transfer of files to be deployed on the mobile device, and the direct transfer of files avoids interfaces with third party applications that are not part of the integrated development environment (IDE) application.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 shows a generalized system where the files are transferred using the plug-in in accordance with an embodiment of the present invention.

FIG. 2 shows a class diagram of the plug-in in accordance with an embodiment of the present invention.

FIG. 3 shows an exemplary screenshot illustrating a mobile registry where different models of mobile devices may be registered in accordance with an embodiment of the present invention.

FIG. 4 is another screenshot illustrating a mobile registry where a selection from among the registered mobile devices has been made to set the default device.

FIG. 5 is a screenshot of the mobile application running on the Netbeans IDE showing some of the available options, which are visible after the plug-in is incorporated in accordance with an embodiment of the present invention.

FIG. 6 is a sequence diagram illustrating the method of operations involved in transferring J2ME application files to a mobile device in accordance with an embodiment of the present invention.

### DETAILED DESCRIPTION

An invention is described below for a system and method for transferring application files from a development station to a real mobile device. It will be obvious, however, to one skilled in the art, that the present invention may be practiced without some or all of these specific details. In other instances, well known process operations have not been described in detail in order not to unnecessarily obscure the present invention.

The embodiments described herein provide a system and method for transferring application files from a development station to a real mobile device. The application file is transferred via Bluetooth technology using a plug-in. The developer registers the mobile device with the integrated development environment (IDE) so that the plug-in works within the IDE. This provides the ability to search for devices associated with the application file to be transferred and transfers the application file automatically to the associated device.

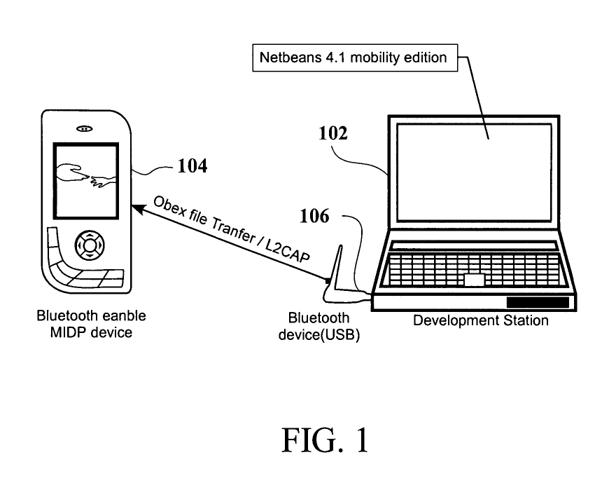

FIG. 1 shows a generalized system where the files are transferred using the plug-in in accordance with an embodiment of the present invention. The system includes a laptop 102, mobile phone 104, and a Bluetooth Device attached via universal serial bus (USB) 106 with the laptop 102. One skilled in the art should understand that laptop 102 and mobile phone 104 of the system may be replaced with other mobile devices such as personal digital assistants (PDAs), etc. It is also understood that the plug-in may be stored in a hard-drive or other storage device connected to the laptop 102. The mobile phone 104 is registered with the IDE so that the plug-in works within the IDE to locate the mobile phone 104 and transfers application files automatically to the mobile device. In one embodiment, the IDE is Netbeans 4.1. Of course, any similar functioning application can be used, and this example is not limited to any particular version. Additionally, the files may be transferred using any protocol. In one embodiment, the protocols used are those, which promote Bluetooth technology. For example, protocols such as the object exchange (OBEX) and logical link control and adaptation protocol (L2CAP) may be used for transferring application files to the mobile device.

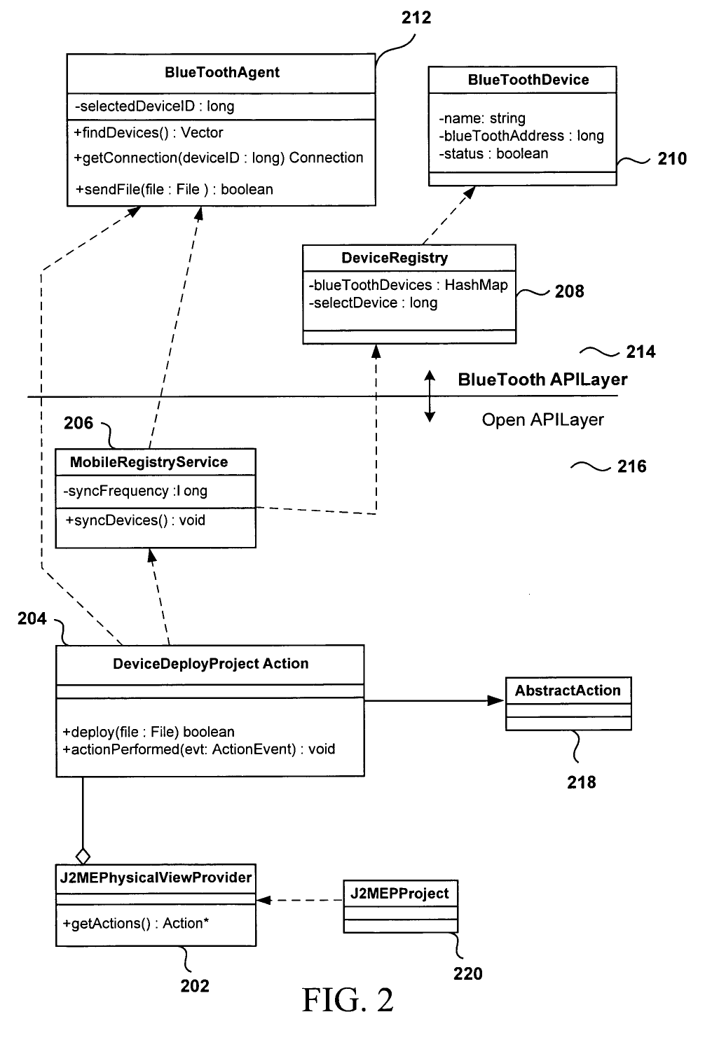

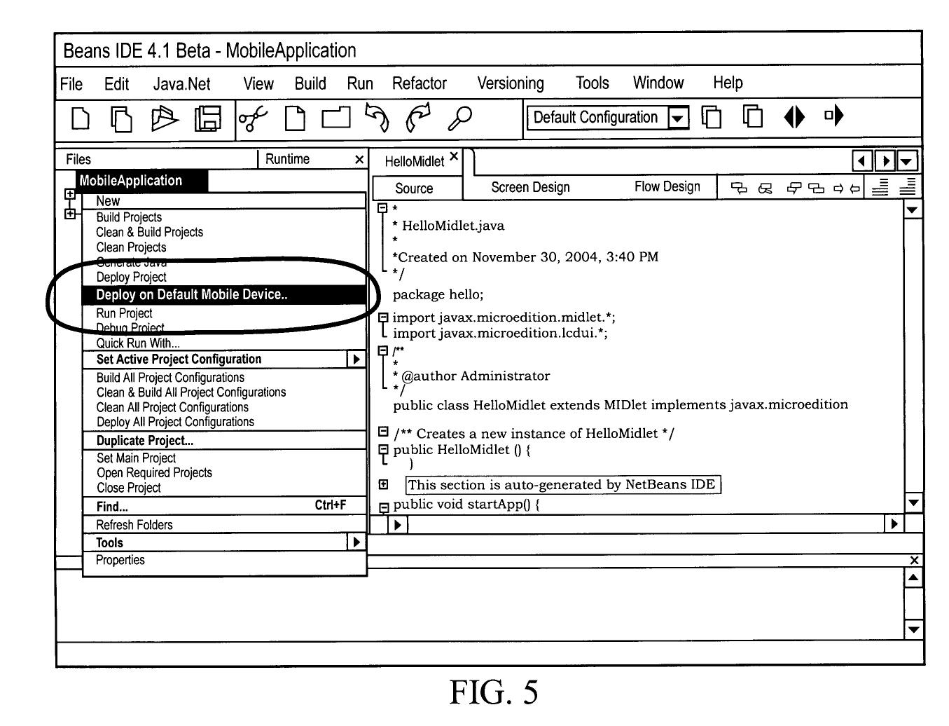

FIG. 2 shows a class diagram of the plug-in, in accordance with an embodiment of the present invention. FIG. 2 includes the BlueTooth API layer 214 and the IDE open API layer 216. The IDE open API layer 216 further includes classes i.e. J2MEPhysicalViewProvider 202, DeviceDeployProjectAction 204 which extends class AbstractAction 218, and MobileRegistryService 206. The IDE open API layer 216 also includes J2MEProject 220 which represents the mobile application(s) to be deployed onto mobile device. In one embodiment, the IDE is Net Beans 4.1. Similarly, the BlueTooth API layer 214 includes classes DeviceRegistry 208, BlueToothDevice 210, and BlueToothAgent 212. The user invokes “Deploy on Default Device action” on the J2MEProject 220 in the IDE by first listing all available actions as shown in FIG. 5. One skilled in the art should understand that the action may be any act such as a select procedure accomplished by invoking class J2MEPhysicalViewProvider 202. In the present example, these actions are retrieved through the getActions( ) method of class J2MEPhysicalViewProvider 202. An example of such an action is the deployment of an application file, such as a (Java archive) JAR file, to a mobile device. Such a selection is made on the mobile application as shown in the highlighted action in the drop-down menu in FIG. 5. Another exemplary invoked action in FIG. 5 is to choose a mobile device, from the dropdown menu, to which the application may be deployed. The selection process may be accomplished through any of the standard procedures such as right clicking on a mouse. As discussed in the succeeding sections, the selection of an action such as file deployment to a mobile device triggers a cascade of method calls in various other IDE open API layer 216 and BlueTooth API layer 214 classes that ultimately results in accomplishment of the desired action.

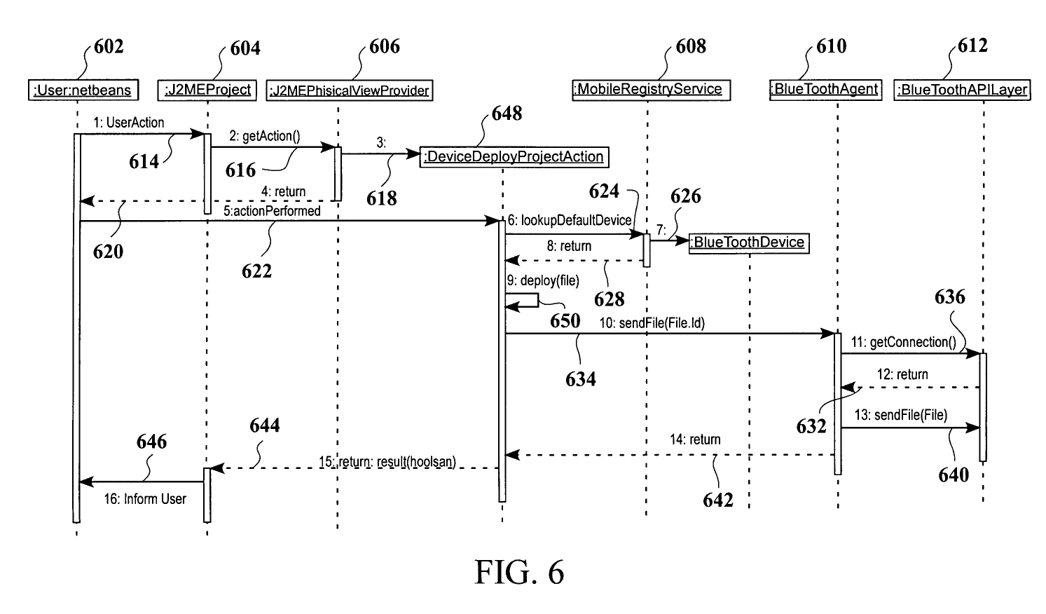

The class DeviceDeployProjectAction 204 is invoked via methods “deploy(file:File): Boolean” and “actionPerformed(evt:ActionEvent):void”. When the user selects the action to deploy an application file the actionPerformed(ActionEvent) method is executed which in turn calls the deploy(File) method that attempts to deploy the file that gets passed in as the argument to the previously selected default mobile device. The sequence diagram in FIG. 6 shows the precise sequence of method calls and returns below. The deploy(File) method of class DeviceDeployProjectAction 204 passes the file along to the sendFile(File) method of the class BlueToothAgent 206 so as to leverage the BlueTooth API layer 214 to complete the action. Class DeviceDeployProjectAction 204 looks up class DeviceRegistry 208 of the BlueTooth API layer 214. In one embodiment, the device registry is maintained by class MobileRegistryService 206, that is running as a Netbeans service to find the devices registered with class DeviceRegistry 208. The class MobileRegistryService 206 synchronizes all available mobile devices returned by the class DeviceRegistry 208 BlueTooth API Layer 214, using the syncDevices( ) method at a frequency established by its syncFrequency attribute. This list of registered devices gets presented to the user for selection. The class MobileRegistryService 206 connects to available mobile devices using the getConnection(deviceid) method of the class BlueToothAgent 212, after locating devices using findDevices( ) method of the class BlueToothAgent 212. The class MobileRegistryService 206 defers to the classDeviceRegistry 208 of the BlueTooth API layer 214 to maintain a HashMap of devices, as BlueToothDevice objects, in the BlueToothDevices attribute. Mobile devices to which the application file to be transferred may be registered with class DeviceRegistry 208 so that a user may select the mobile device to which the Application files may be transferred.

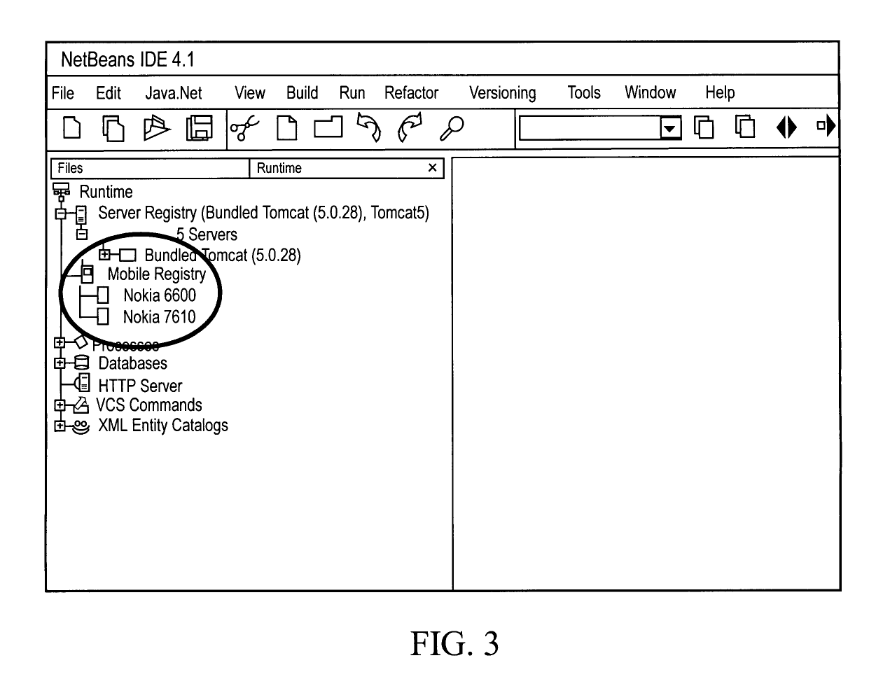

FIG. 3 shows an exemplary screen shot illustrating a mobile registry where different models of the mobile devices may be registered in accordance with an embodiment of the present invention. As can be seen, the plug-in integrates with the features of the NetBeans IDE 4.1 so that plug-in provides native-like functionality for the transfer of files to be deployed on the mobile device. In this instance the mobile registry provides the user an avenue from which a mobile selection can be made, In FIG. 3, the user may register the mobile devices to which the application file is to be transferred in the IDE. The registered mobile devices, for example, are shown as mobile phones manufactured by Nokia, with model numbers 6600 and 7610. One skilled in the art should understand that the models shown are exemplary and are not meant to be limiting. For instance, other models from other manufacturers such as Motorola and Ericsson may also be registered with the mobile registry. Also, other mobile devices such as PDAs by different manufacturers may be registered with the IDE.

In one embodiment, the application file is a J2ME application file. Having the mobile devices registered with the IDE simplifies the process of deploying an application file into the mobile device. Through the IDE, the developer will be able to compile the code, pre-verify the code, package the application file, and deploy the application file into the mobile device. In one embodiment, a Java archive (JAR) file format allows the developer to bundle multiple J2ME application files into a single archive file. In another embodiment, the JAR file may contain class files and auxiliary resources associated with the J2ME application file. One skilled in the art should understand that even though FIG. 3 shows the Netbeans IDE 4.1 other suitable IDEs may be used in place of Netbeans IDE 4.1.

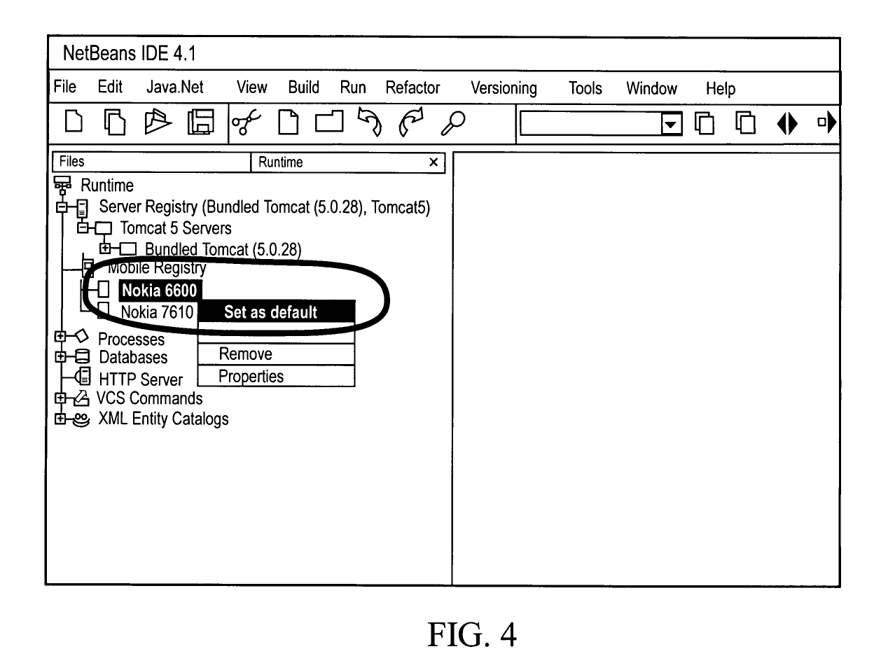

FIG. 4 is another screenshot illustrating a mobile registry where a selection among the registered mobile devices has been made. In this screenshot, Nokia 6600 is selected from the two models listed above with respect to FIG. 3. Moreover, the Nokia 6600 model is set as the default mobile device to which the application files is to be transferred. By setting Nokia 6600 as the default mobile device, the developer can transfer application files automatically to the mobile device in the future without any further selection.

FIG. 5 is a screenshot illustrating Netbeans IDE 4.1 highlighting the fields which are visible after the plug-in is incorporated, in accordance with an embodiment of the present invention. The visible part includes deploying the Application files onto the mobile device or the default mobile device selected above with respect to FIGS. 3 and 4.

Referring back to FIG. 2, class MobileRegistryService 206 synchronizes the list of the of available mobile devices for deployment. Then, class MobileRegistryService 206 establishes connection with the selected mobile device and transfers the application file into the mobile device. In one embodiment, the connection is an L2CAP connection or any other type of low level connection. In one embodiment, an acknowledgment is sent to the user that the application file has been transferred. In another embodiment, a confirmation is sent to the user that the application file transfer is successful.

FIG. 6 is a sequence diagram illustrating the method of operations involved in transferring an application file to a mobile device in accordance with an embodiment of the present invention. One skilled in the art should understand that even though FIG. 6 illustrates operations for a J2ME application file transfer, other types of application files may be transferred using the method of operations described below. In operation 614, a user invokes a user action on a J2ME project 604 opened in Netbeans IDE 602. In response, a class J2MEPhysicalViewProvider 606 is invoked via method getActions( ) in operation 616. The user makes a selection from the operation 618 and a choice is made as to the mobile device to which the application file is to be deployed. The selected mobile device is returned to the user in operation 620. As described above, the user may designate a particular mobile device as a default. This can save time in the future since the mobile device selection process can be bypassed until an alternate default device needs to be selected. The plug-in can automatically deploy the application file to the mobile device which is set as a default device.

Subsequently, in operation 622 class DeviceDeployProjectAction 648 is invoked via method actionPerformed(evt). Operation 622 is essentially requesting that the J2ME application file be deployed to the mobile device selected by the user, via a call to the deploy(file) method. In response, the selected mobile device is looked up in operation 624 as described in the discussion with respect to FIG. 2. All available BlueToothDevices accessed in operation 626 are returned to the mobile registry in operation 628. Once the mobile device to which the J2ME application file to be deployed is found, the file is deployed as shown in operation 650. When deploying the plug-in will read the J2ME application file from a directory. The plug-in is configured to know which directory the J2ME application belongs to. In one embodiment, the directory structure is mandated by the Netbeans IDE. The method sendFile(File,id) is used to invoke agent 610 in operation 634. In one embodiment, the agent is a BlueToothAgent. This further calls the sendFile(File) method in the BlueTooth API layer 214 of FIG. 2 as in operation 640. The plug-in establishes a connection to the BlueToothAPLayer 612 via a getConnection( ) call as shown in operation 636. Once the connection is obtained in operation. 632, the J2ME application file is sent to the mobile device. A confirmation of the successful deployment of the J2ME application file is relayed back to the user as shown in operations 642, 644, and 646.

In summary, the above-described invention provides a system and method for deploying an application files directly into mobile devices from other devices, in an 1DE, without depending on a third party. The deployment of the file is facilitated by a plug-in, which establishes a Bluetooth or other similar connection with the mobile device and transfers the file directly into the mobile device. The use of Bluetooth technology in the plug-in allows the IDE to compile, pre-verify, and package the code of an application file and deploy the application file into the mobile device in a “one click” process.

The plug-in described above may be incorporated into any suitable computing device. Exemplary computing devices include servers, desktop computers, personal digital assistants, workstations, supercomputers, etc. With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as, producing, identifying, determining, or comparing.

Any of the operations described herein that form part of the invention are useful machine operations. The invention also relates to a device or an apparatus for performing these operations. The apparatus may be specially constructed for the required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The above-described invention may be practiced with other computer system configurations including hand-held devices, microprocessor systems, microprocessor-based or programmable consumer electronics, minicomputers, mainframe computers, and the like. Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

What is claimed is:

1. A method for deploying an application file from a development station directly to a mobile device, at the development station executing operations comprising:
receiving a list of mobile devices registered with an integrated development environment (ODE) application being executed on the development station;
selecting a mobile device from the list of mobile devices;
selecting the application file to be deployed to the mobile device;
deploying the application file to the mobile device, wherein deploying includes triggering methods of a plug-in application, the plug-in application executing operations for,
establishing a wireless connection between the development station and the mobile device; and
upon establishing the wireless connection, transferring the application file to the mobile device over the wireless connection.

2. A method of claim 1, wherein the plug-in application integrates with features of the integrated development environment (IDE) application, so that the plug-in provides native-like functionality for the transfer of files to be deployed on the mobile device.

3. A method of claim 2, wherein the native-like functionality is presented by insertion of graphical user interface selection controls into native graphical user interface controls of the integrated development environment (IDE) application.

4. A method of claim 1, wherein the wireless connection is a Bluetooth connection.

5. A method claim 1, wherein the IDE application is a Netbeans application.

6. A method of claim 1, wherein components of the plug-in application provide functionality for setting a mobile device as a default device, the mobile device being identified as the default device triggers the plug-in application to first attempt transferring the application file to the mobile device over the wireless connection.

7. A method of claim 1, wherein one or more application files defines a Java archive (JAR) file, such that the application file transferred to the mobile device is a JAR file.

8. A method of claim 1, wherein the wireless connection implements an object exchange (OBEX) file transfer protocol to complete the transfer of files to the mobile device.

9. A method of claim 1, wherein the wireless connection implements a logical link control and adaptation protocol (L2CAP) to complete the transfer of files to the mobile device.

10. A method for deploying an application file from a development station directly to a mobile device, at the development station executing operations comprising:
identifying a list of mobile devices registered with an integrated development environment (IDE) application that is configured to be executed on the development station;
enabling selection of a mobile device from the list of mobile devices;
identifying the application file to be deployed to the mobile device;
deploying the application file to the mobile device, wherein deploying includes triggering methods of a plug-in application, the plug-in application executing operations for,
establishing a wireless connection between the development station and the mobile device; and
upon establishing the wireless connection, transferring the application file to the mobile device over the wireless connection
wherein the plug-in application integrates with features of the integrated development environment (IDE) application, so that the plug-in provides native-like functionality for the direct transfer of files to be deployed on the mobile device, the direct transfer of files avoiding interfaces with third party applications that are not part of the integrated development environment (IDE) application.

11. A method of claim 10, wherein the native-like functionality is presented by insertion of graphical user interface selection controls into native graphical user interface controls of the integrated development environment (IDE) application.

12. A method of claim 10, wherein the wireless connection is a Bluetooth connection.

13. A method claim 10, wherein the IDE application is a Netbeans application.

14. A method of claim 10, wherein components of the plug-in application provides functionality for setting a mobile device as a default device, the mobile device being identified as the default device, triggers the plug-in application to first attempt transferring the application file to the mobile device over the wireless connection.
